(19) United States
(12) Patent Application Publication
(10) Pub. No.: US 2009/0277857 A1
(43) Pub. Date: Nov. 12, 2009

(54) PORTABLE CRANE AND TRAILER SYSTEM

(76) Inventor: John Rice, Lakeland, FL (US)

Correspondence Address: McKinney Law, LLC, 121 S. Orange Ave, Suite 1500, Orlando, FL, 32801, US

(21) Appl. No.: 12/464,768

(22) Filed: May 12, 2009

Related U.S. Application Data
(60) Provisional application No. 61/052,369, filed on May 12, 2008.

(51) Int. Cl. B66C 23/36; B66C 23/16; B66C 23/62; B66C 23/78; B66C 23/38; B66C 23/06

(52) U.S. Cl. 212/302; 212/223; 212/238; 212/294; 254/323

(57) ABSTRACT

A portable crane and trailer system is disclosed. In a particular embodiment, the system includes a trailer, a crane post, and a crane. A first pair of outriggers is secured to a rear portion of the trailer and a second pair of outriggers is configured to be swung out rearward from the trailer to further increase the stability of the trailer, where the second pair of outriggers is deployed at approximately a 45 degree angle relative to the trailer. In addition, the system includes a removable A-frame removably connected between the rear portion of the trailer and the boom, where a first end of the A-frame is mounted to the rear portion of the trailer forming a base of the A-frame and a second end of the A-frame is connected at approximately the same location on the boom forming an apex of the A-frame.

### I. CROSS REFERENCE TO RELATED APPLICATIONS

This application claims the benefit of U.S. Provisional Application No. 61/052,369 filed May 12, 2008. The disclosure of the provisional application is incorporated herein by reference.

### II. FIELD

The present invention relates generally to cranes, and more particularly to a portable crane and trailer system.

### III. DESCRIPTION OF THE RELATED ART

Hydraulic cranes are generally required to remove and install wastewater pumps in lift station wells that are located below grade. Typically, the hydraulic crane is mounted to a truck that can weigh as much as 8,800 pounds. The truck is backed up to the lift station well or shaft. The truck may crush underground pipes and utilities when attempting to access the well as the weight of the truck must be placed close to an edge of the well. Accordingly, what is needed in the art is a portable crane and trailer system that has the high capacity to lift wastewater pumps from wells below grade but is relatively lightweight.

In addition, a truck-mounted crane is expensive to acquire in addition to being expensive to operate and maintain. Further, if the truck breaks down, the crane cannot be transported to the site. When the crane is not required, technicians drive the heavy-duty trucks around performing routine service work and using large amounts of fuel. Accordingly, what is needed in the art is a portable crane and trailer system that is not mounted to a truck.

An example of the prior art is U.S. Pat. No. 6,966,448 to Burkett, which describes a portable crane mounted on a small two-wheeled trailer. The crane is used to support a vibrational sheet piling driver. A shortcoming of Burkett is that the crane is susceptible to tipping if a heavy load is lifted with the crane and otherwise has limited lifting capacity. Further, there is no storage area on the trailer to transport large and heavy equipment, such as wastewater pumps. Accordingly, there is a need in the art for a portable crane and trailer system that has increased lifting capacity and has the ability to transport heavy equipment (e.g., submersible pump).

Notwithstanding the existence of prior art cranes, there is a need for an improved portable crane and trailer system. It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### IV. SUMMARY

In a particular embodiment, a portable crane and trailer system is disclosed. The system includes a trailer, a crane post, where a lower end of the crane post is mounted to the trailer and a crane is mounted to an upper end of the crane post, and a plurality of wheels mounted to the trailer. A first end of the crane post is mounted substantially vertical and proximate to a rear portion of the trailer. The crane includes a cable drum configured to wind and unwind a cable, a boom, where a first end of the boom is secured to the upper end of the crane post and adapted to rotate about the crane post, a pulley mounted to an end of the boom, and a block secured to the cable. A hydraulic piston is configured to lift the boom to a desired angle relative to the trailer. In addition, the trailer includes a removable resting post adapted to receive the boom, where the resting post is configured to be inserted into one of a plurality of receptacles located on the trailer. A first pair of outriggers is secured to a rear portion of the trailer, where the first pair of outriggers is adapted to stabilize the trailer as an object is lifted by the boom. A second pair of outriggers is configured to be swung out rearward from the trailer to further increase the stability of the trailer, where the second pair of outriggers is deployed at approximately a 45 degree angle relative to the trailer. In addition, the system may include a removable A-frame, the A-frame consisting of a pair of support members removably connected between the rear portion of the trailer and the boom, where a first end of each of the A-frame support members is mounted to the rear portion of the trailer forming a base of the A-frame and a second end of each of the A-frame support members is connected at approximately the same location on the boom forming an apex of the A-frame.

The portable crane and trailer system may include a telescoping boom with a reach of 15 feet and with the ability to rotate 360 degrees. The boom may be manually extended or an optional hydraulic cylinder may be installed to extend the second section of the boom with switches mounted on a control pendant. The portable crane and trailer system may be rated for 3200 lbs lifting capacity; however, the system is adaptable to both smaller and larger capacities.

The trailer is adapted to use a vehicle as ballast (i.e., counter weight) with the trailer serving as a lever and the wheels and/or outriggers as fulcrum points. The rear outriggers or stabilizers may be implemented in a variety of positions. For example, outriggers may be installed at the side or rear of the trailer thus allowing the center of gravity (i.e. fulcrum) location to be positioned further rearward. This allows a “stand alone” usage of the trailer and crane, which frees up the towing vehicle for other purposes. The trailer tongue may be held down during a lift by means of a specially designed pintle or clevis type hitch.

A battery may be installed on the trailer tongue deck for powering the crane or a gas driven generator may be used. The controls for the crane may include a pendant switch unit or wireless control.

The bed of the trailer is fitted with multiple rings for tying down and transporting items such as pumps, motors and other equipment. The trailer also serves as a mobile repair platform and can be fitted with a generator so the trailer and crane can be self sustaining. In addition the crane and trailer may be used without a towing vehicle coupled to the trailer.

It is therefore an object of the present invention to provide for an improvement that overcomes the aforementioned inadequacies of the prior art and provides a significant contribution to the advancement of cranes.

Both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

### V. BRIEF DESCRIPTION OF THE DRAWINGS

For a fuller understanding of the nature and objects of the invention, reference should be made to the following detailed description, taken in connection with the accompanying drawings, in which:

FIG. 1 is a right side view of a particular embodiment of a portable crane and trailer system;

FIG. 2 is a rear view of the particular embodiment of the portable crane and trailer system shown in FIG. 1;

FIG. 3 is a side view of structural components of the particular embodiment of the trailer shown in FIG. 1 and FIG. 2;

FIG. 4 is a top view of the structural components of the particular embodiment of the trailer shown in FIG. 3;

FIG. 5A is a partial side view of a particular embodiment of the portable crane and trailer system in operation and showing a second pair of outriggers;

FIG. 5B is a partial top view of the particular embodiment of the portable crane and trailer system shown in FIG. 5A;

FIG. 6A is a partial side view of a particular embodiment of the portable crane and trailer system in operation and showing an A-frame boom support; and

FIG. 6B is a partial top view of a particular embodiment of the portable crane and trailer system shown in 6A.

### VI. DETAILED DESCRIPTION

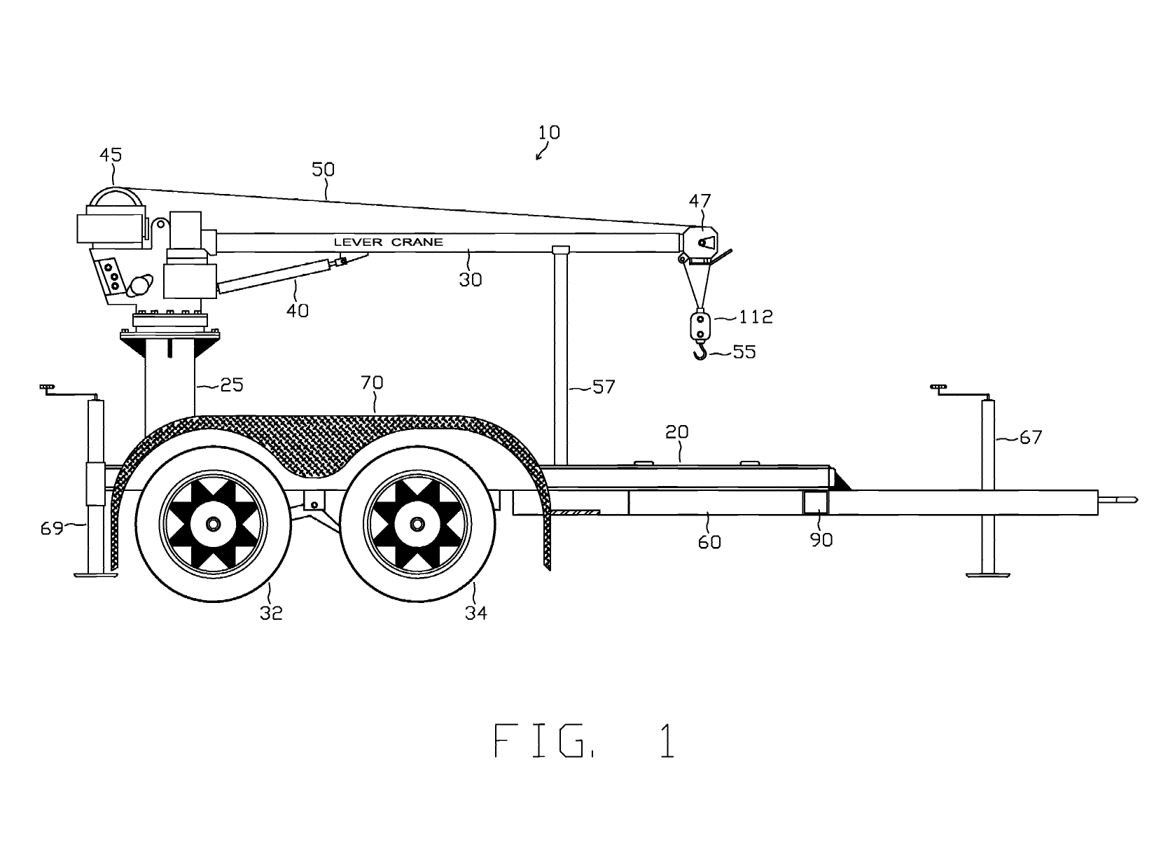

Referring to FIG. 1, a particular illustrative embodiment of a portable crane and trailer system is disclosed and generally designated 10. The system 10 includes a trailer 20 that serves as a platform for a crane post 25. The trailer includes a frame 60 and fenders 70 that are mounted to the trailer 20 to protect wheels 32 and 34 mounted adjacent to each other. Forward outriggers (not shown) may be inserted into outrigger tubes 90 to provide additional stability to the trailer 20 when heavy objects are swung from the rear of the trailer 20 to the flatbed surface of the trailer 20 for transporting or repairing the object (e.g., a pump). The forward outriggers may also used for greater stability when the trailer 20 is unhitched from a towing vehicle.

An advantage of the portable crane and trailer system 10 is that the trailer 20 is relatively lightweight and configured to access areas that large equipment cannot access without crushing underground pipes and utilities. In addition, a fence, hedge or soft ground may prevent easy access. Thus, the portable crane and trailer 10 has the ability to meet tight accessibility requirements and low weight constraints never before achievable.

A first end of the crane post 25 is mounted substantially vertical and proximate to the rear of the trailer 20. A boom 30 is mounted to a top of the crane post 25. The length of the boom 30 is approximately one-half the length of the trailer 20. In operation, the boom 30 is swung about the crane post 25 from a position over the trailer 20 (as shown in FIG. 1) to a desired location behind, or to the side, of the trailer 20. A hydraulic piston 40 is used to lift the boom 30 to a desired angle relative to the trailer 20 in order to obtain a mechanical advantage for lifting an object. A cable drum 45 is used to raise and lower the object via a cable 50, which runs from the cable drum 45 to the distal end of the boom 30, to a pulley 47, and to a block 113. A hook 55, or other connection means, is used to grasp strapping or other lifting point of the object. The object may be, for example, a wastewater pump that needs to be removed and a new wastewater pump installed in its place. Wastewater pumps, i.e., lift station pumps, are typically located in shafts or wells below grade thus making it difficult to extract manually. Accordingly, as the cable 50 is reeled in on the cable drum 45, the object may be raised from below grade and, alternatively, as the cable is let off the cable drum 45, the object is lowered. The speed at which the object is raised or lowered is dependent in part on the size and speed of the cable drum 45.

When the boom 30 is in a transport mode or otherwise not needed, the boom 30 is placed within a removable resting post 57, which serves to reduce stress on the hydraulic piston 40 and the boom 30. The resting post 57 may be inserted into one of a plurality of receptacles located on the trailer 20 at the center, right or left positions. Thus, the boom 30 may be swung over and stored on the trailer 20 in a location to avoid taking up space on the trailer 20 that otherwise may accommodate a load for transporting to or from the work site. For example, a lift station pump may be removed and raised from the well using the boom 30. The lift station pump is then swung over to the trailer 20 using the boom 30 as the boom 30 is rotated about the crane post 25. The pump may then be lowered onto the trailer 20 for transport. The resting post 57 may be removed during the loading of the lift station pump to keep the trailer 20 clear to ease the loading and unloading operations. Once the lift station pump has been secured to the trailer 20 for transport, the resting post 57 may be reinserted and the boom 30 lowered into position on the resting post 57 as shown in FIG. 1.

The trailer 20 includes a frame 60, which provides structural support for the portable crane and trailer system 10. A first pair of outriggers 69, 71 at the rear of frame 60 may be used to stabilize the trailer 20 as a load is lifted by the boom 30. The right side outrigger 69 is visible in FIG. 1. A front support 67 is used to stabilize the front portion of the trailer 20 when unhitched from a towing vehicle.

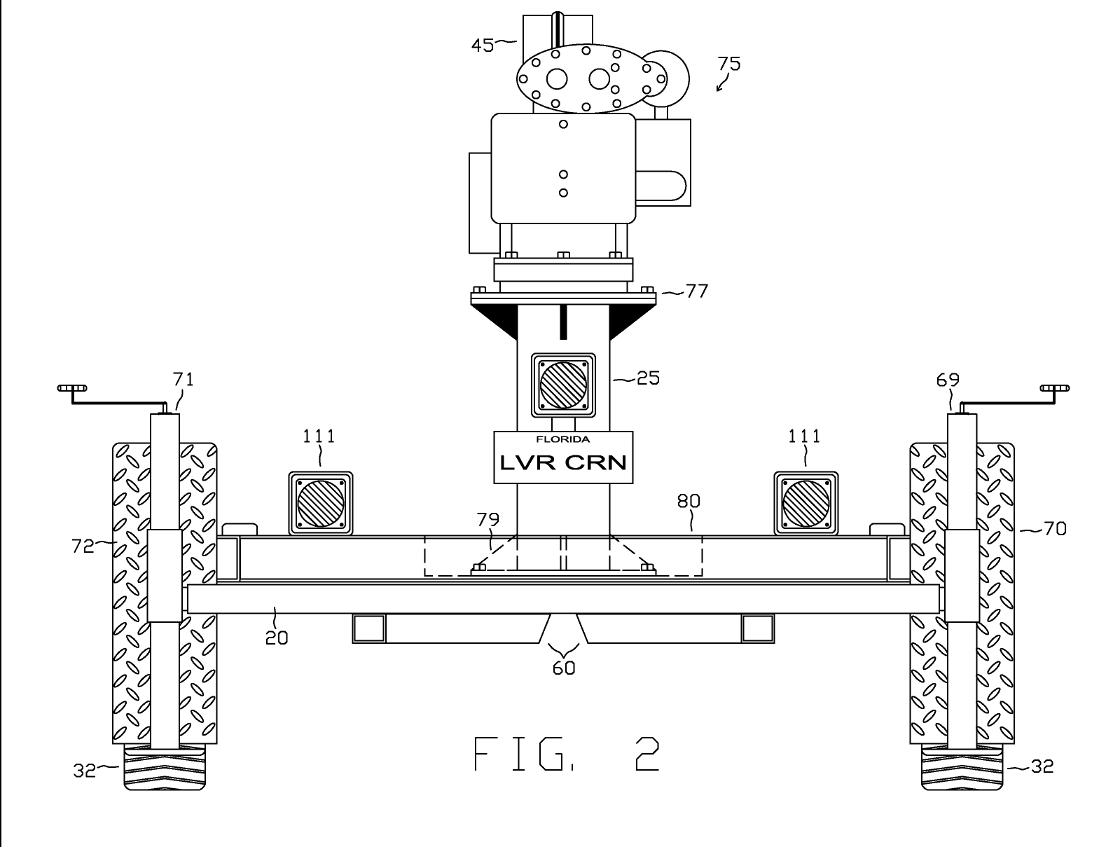

Referring now to FIG. 2, the first pair of outriggers 69, 71 are shown in a raised position and attached to the trailer 20 on each side. The first pair of outriggers 69, 71 each include an inner cylinder that may be raised and lowered by turning a handle located at the top portion of each outrigger 69, 71. As the handle is cranked in either a clockwise or counterclockwise motion, the inner cylinder extends or retracts from within an outer housing of the respective outrigger 69, 71. When the first pair of outriggers 69, 71 are in a lowered position, the center of gravity for trailer 20 is moved proportionally rearward allowing the boom 30 to lift more weight with less ballast at the front end of the trailer 20. The boom 30 is approximately one-half the length of the trailer 20, so that as the length of the trailer 20 is increased, the mechanical advantage is also increased when the towing vehicle is used as ballast. In addition, outriggers 69, 71 provide stability to the trailer 20, especially when the object 202 is being swung around from the rear of the trailer 20 and placed on the trailer 20, or vice versa.

An electric motor 75 may be used to drive the cable drum 45 and the hydraulics to operate the boom 30. The lower first end of the crane post 25 includes flanges and a wide base, which may be mounted to the trailer 20 using bolts to provide an elevated support for the boom 30 at the top of the crane post 25. Although the boom 30 is shown for exemplary purposes, other deck mounted devices may be used with the trailer 20 such as back hoes, hole diggers, man lifts, and other specialized equipment. Diamond plate decking 80 may be used to cover the trailer frame 60 and to provide the flat surface for transporting equipment and objects such as lift station pumps. Work lights 111 may be mounted to the rear of the trailer 20 to illuminate the work site in low light conditions.

FIG. 3 illustrates the structural components of the trailer 20. For example, the trailer 20 may include 2×2 steel tubing 87 to form lower structural components of the trailer 20. Overlaying the steel tubing 87 may be C-channels 80 that are substantially equidistantly spaced along the length of the trailer 20. In addition, the trailer 20 may include D-rings 89 that are mounted along an outside edge of the trailer 20 and may be used to secure equipment and objects (e.g., wastewater pumps) to the trailer 20 during transport. Gusset plates 92 may be used to reinforce the connections between the structural components of the trailer 20. The trailer 20 may also include additional outrigger tubes 90 welded on each side of the rear of the trailer 20 so that the first pair of outriggers 69, 71 may slide in and out to the desired position as necessary. A front hitch 65 is configured to couple to a hitching device of the towing vehicle. Thus, the front end of the trailer 20 may be held down by the weight of the towing vehicle (i.e., ballast) when the boom 30 is being used to lift an object at the rear of the trailer 20. Alternatively, the portable crane and trailer system 10 may be towed to a work site and the towing vehicle can be uncoupled from the trailer 20 so that the towing vehicle can be used for other purposes.

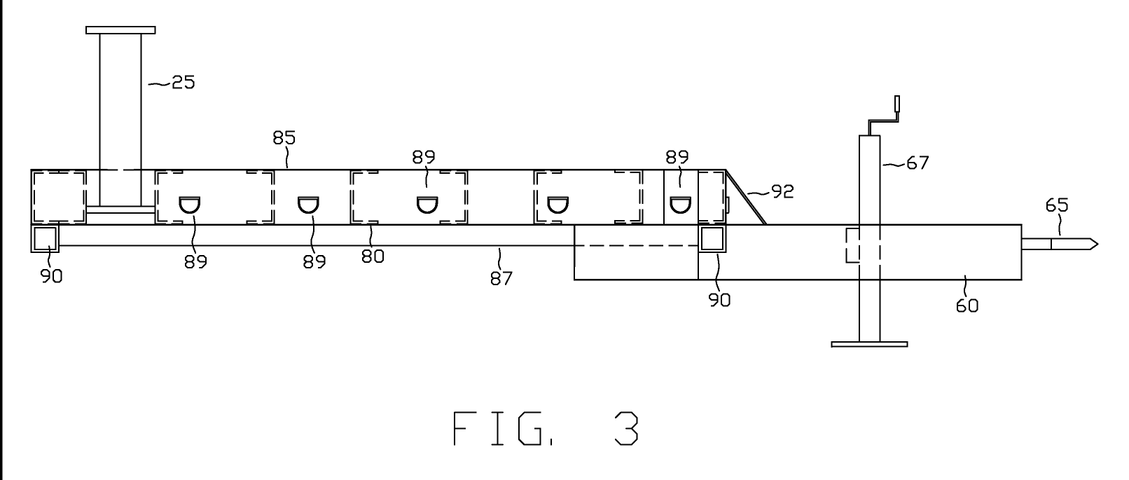

Referring now to FIG. 4, a front support 67 is mounted proximate to the front of the trailer 20 and substantially equidistantly spaced between the side rails 108 of the trailer 20. The diamond plate decking 80 may be used to cover the trailer 20 and to provide a flat surface to transport equipment and objects. A breakaway kit 95 may be mounted to an interior surface of the trailer frame 60 to prevent the trailer 20 from being damaged in the event the trailer 20 inadvertently becomes uncoupled from the towing vehicle during transit. A step 99 may be provided at the side of the trailer 20 so that a worker can easily gain access to the trailer 20 to tie down equipment being transported, for example. The work lights 111 may be attached to a 2×2 post inserted into any of a multiple of receptacles 110 provided along the top portion of the trailer 20. The receptacles 110 may also be utilized for the insertion of side walls (not shown). The crane post 25 is mounted to the trailer 20 using a base plate 104 that spans between a pair of longitudinal 2×4 steel tubes 106 and a pair of C-channels 85 and provides the mounting surface for the crane post 25. The side rails 108 may be comprised of 4×3 C-channel and provide rigidity and strength to the frame 60. Stake pockets 97 may be welded to a front portion of the side rails 108.

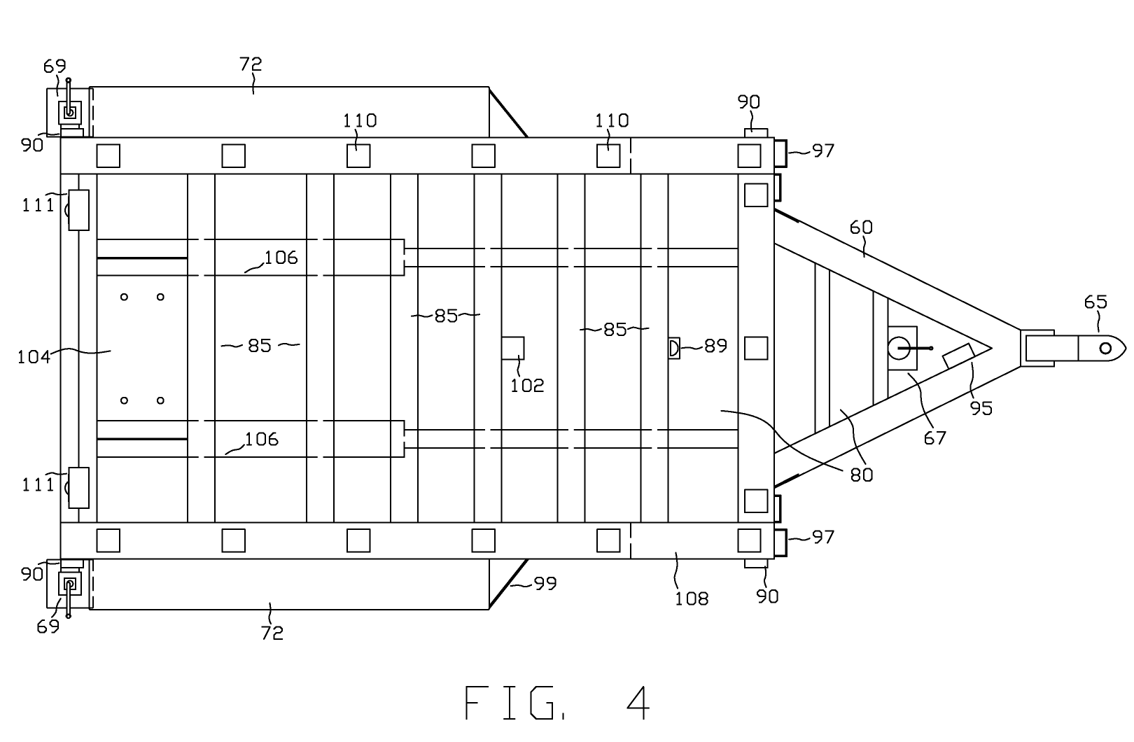

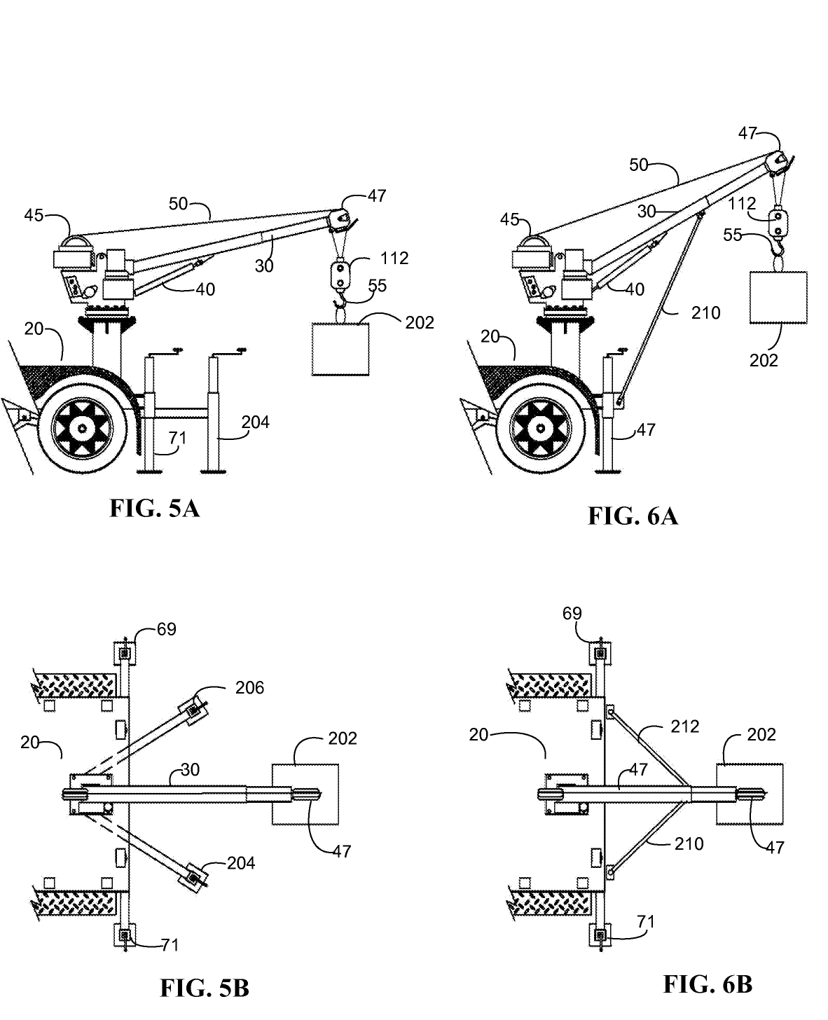

In operation, the boom is swung to the rear of the trailer 20 as shown in FIGS. 5A and 5B. A second pair of outriggers 204, 206 are swung out rearward to further increase the stability of the trailer 20 when the object 202 is being raised or lowered. The second pair of outriggers 204, 206 are deployed at approximately a 45 degree angle relative to the trailer 20 and provide increased lifting capacity to the boom 30. The first pair of outriggers 69, 71 and the second pair of outriggers 204, 206 are in the down position in FIGS. 5A and 5B and are providing stability and support to the trailer 20. The first pair of outriggers 69, 71 and the second pair of outriggers 204, 206 may be used alone or in any combination thereof.

Referring now to FIGS. 6A and 6B, the portable crane and trailer system 10 may include an A-frame that consists of a pair of support members 210, 212 removably connected between the rear of the trailer 20 and the boom 30. A first end of each of the A-frame support members 210, 212 is mounted to the rear of the trailer 20, forming a base of the A-frame. A second end of each of the A-frame support members 210, 212 is connected at approximately the same location on the boom 30, forming an apex of the A-frame. The A-frame support member 210, 212 are rigid and provide additional strength to the boom 30 to allow lifts to be made at greater distances (reach) than could otherwise be achieved without the A-frame. The length and size of the A-frame support members 210, 212 may vary dependent on the particular application.

In operation, the boom 30 is raised and positioned so that the A-frame support members 210, 212 can be installed. Once the A-frame support members 210, 212 are installed, the boom 30 is ready to raise and lower the object 202. For example, the object 202 is first secured to the boom 30, and then the cable 50 is reeled in on the cable drum 45 to lift the object 202. The boom 30 is supported by the A-frame support members 210, 212 that transfer the structural load from the boom 30 to the rear of the trailer 20, thereby relieving and assisting the load on the hydraulic piston 40. After the object 202 is raised, the trailer 20 may be pulled forward by the towing vehicle with the object 202 in a raised position to move the object 202 away from the well where the object 202 (e.g., lift station pump) was removed. The object 202 may then be lowered down to the ground by unwinding the cable 50 from the cable drum 45 until the object is 202 no longer supported by the boom 30.

The A-frame support members 210, 212 increases the lifting capacity of the boom 30 and allows the lifting of heavier objects farther away from the crane post 25 center line. For example, the boom 30 reach without the A-frame is approximately 8 ft. for a 1250 lb. object 202. With the A-frame, tests show that the reach of the boom 30 is 11 ft., which is a 38% increase in reach. Additional reach is possible by extending the telescoping boom 30 out further, but at a reduced lifting capacity.

The A-frame support members 210, 212 provide a significant advantage when pulling lift station pumps or other heavy objects located below grade. The A-frame support members 210, 212 can be installed quickly to the boom 30. Likewise, the A-frame support members 210, 212 are easily removed and stowed away.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A portable crane and trailer system, the system comprising:
a trailer, wherein the trailer is adapted to be pulled by a towing vehicle;
a crane post, wherein a lower end of the crane post is mounted to the trailer;
a crane mounted to an upper end of the crane post; and
a plurality of wheels mounted to the trailer, wherein the trailer is adapted to roll on the plurality of wheels.

2. The portable crane and trailer system of claim 1, wherein a first end of the crane post is mounted substantially vertical and proximate to a rear portion of the trailer.

3. The portable crane and trailer of claim 2, the crane further comprising:
a cable drum configured to wind and unwind a cable;
a boom, wherein a first end of the boom is secured to the upper end of the crane post and adapted to rotate about the crane post;
a pulley mounted to an end of the boom; and
a block secured to the cable.

4. The portable crane and trailer system of claim 3, further comprising:
a hydraulic piston configured to lift the boom to a desired angle relative to the trailer.

5. The portable crane and trailer system of claim 4, further comprising:
a diamond plate decking to cover the trailer; and
work lights mounted to a rear portion of the trailer to illuminate a work site in low light conditions.

6. The portable crane of claim 5, further comprising:
a hook secured to the block, wherein the hook is adapted to grasp strapping or other lifting point of an object.

7. The portable crane and trailer of claim 6, the trailer further comprising:
a removable resting post adapted to receive the boom, wherein the resting post is configured to be inserted into one of a plurality of receptacles located on the trailer.

8. The portable crane and trailer system of claim 7, further comprising:
a first pair of outriggers secured to a rear portion of the trailer, wherein the first pair of outriggers are adapted to stabilize the trailer as an object is lifted by the boom.

9. The portable crane and trailer system of claim 8, further comprising:
a front support adapted to stabilize a front portion of the trailer when unhitched from a towing vehicle.

10. The portable crane and trailer system of claim 9, further comprising:
an electric motor configured to drive the cable drum and hydraulics to operate the boom.

11. The portable crane and trailer system of claim 10, further comprising:
a second pair of outriggers configured to be swung out rearward from the trailer to further increase the stability of the trailer, wherein the second pair of outriggers are deployed at approximately a 45 degree angle relative to the trailer.

12. The portable crane and trailer system of claim 11, further comprising:
a removable A-frame, the A-frame comprising a pair of support members removably connected between the rear portion of the trailer and the boom, wherein a first end of each of the A-frame support members is mounted to the rear portion of the trailer forming a base of the A-frame and a second end of each of the A-frame support members is connected at approximately the same location on the boom forming an apex of the A-frame.

13. The portable crane and trailer system of claim 12, wherein the trailer further comprising:
steel tubing to form lower structural components of the trailer; and
C-channel steel overlaying the steel tubing, wherein the C-channel steel is substantially equidistantly spaced along the length of the trailer.

14. The portable crane and trailer system of claim 13, further comprising:
D-rings mounted along an outside edge of the trailer, wherein the D-rings are configured to secure equipment and objects to the trailer.

15. The portable crane and trailer system of claim 14, wherein the trailer further comprising gusset plates to reinforce connections between structural components of the trailer.

16. The portable crane and trailer system of claim 15, further comprising:
a plurality of outrigger tubes secured to the trailer, wherein the outrigger tubes are adapted to removably receive outriggers.

17. The portable crane and trailer system of claim 16, further comprising:
a front hitch, wherein the front hitch is configured to couple to a hitching device of the towing vehicle.

18. A portable crane and trailer system, the system comprising:
a trailer, wherein the trailer is adapted to be pulled by a towing vehicle;
a crane post, wherein a lower end of the crane post is mounted to the trailer;
a crane mounted to an upper end of the crane post;
a first pair of outriggers secured to a rear portion of the trailer, wherein the first pair of outriggers are adapted to stabilize the trailer as an object is lifted by the crane; and
a second pair of outriggers configured to be swung out rearward from the trailer, wherein the second pair of outriggers are deployed at approximately a 45 degree angle relative to the trailer.

19. A portable crane and trailer system, the system comprising:
a trailer, wherein the trailer is adapted to be pulled by a towing vehicle;
a crane mounted to the trailer; and
a removable A-frame, the A-frame comprising a pair of support members removably connected between a rear portion of the trailer and the crane, wherein a first end of each of the A-frame support members is mounted to the rear portion of the trailer forming a base of the A-frame and a second end of each of the A-frame support members is connected at approximately the same location on the crane forming an apex of the A-frame.

20. The portable crane and trailer system of claim 19, wherein the crane further comprising a boom, wherein a length of the boom is approximately one-half a length of the trailer.
